(19) United States
(12) Patent Application Publication
(10) Pub. No.: US 2015/0294592 A1
(43) Pub. Date: Oct. 15, 2015

(54) TRAINING DEVICE AND METHOD

(71) Applicants: Joseph F. Clark, Cincinnati, OH (US); James K. Ellis, Cincinnati, OH (US)

(72) Inventors: Joseph F. Clark, Cincinnati, OH (US); James K. Ellis, Cincinnati, OH (US)

(21) Appl. No.: 14/437,876

(22) PCT Filed: Oct. 23, 2013
(86) PCT No.: PCT/US13/66412

§ 371 Date: Apr. 23, 2015

Related U.S. Application Data
(60) Provisional application No. 61/717,623, filed on Oct. 23, 2012.

(51) Int. Cl. G09B 19/00

(52) U.S. Cl. CPC G09B 19/003

(57) ABSTRACT

Described herein are devices and methods for training a subject to maintain their head in a proper position during an activity by training the individual to concentrate on a focal point and to maintain a constant line of sight during an activity. An aspect of the invention is directed to devices and methods utilizing retinal retention to train the subject to focus on a focal point during an activity. Another aspect of the invention is directed to devices and methods utilizing visual memory acquisition to train the subject.

### CROSS-REFERENCE TO RELATED APPLICATION

This application claims the priority of Application Ser. No. 61/717,623, filed Oct. 23, 2012 (pending), the disclosure of which is hereby incorporated by reference herein.

### FIELD

The invention relates generally to devices and methods for training a subject to concentrate on a focal point in a visual field and more particularly to devices and methods for training a subject to concentrate on a focal point in a visual field while engaging in an activity.

### BACKGROUND

In order to be successful in many types of activities, a subject is required to concentrate on a specific focal point and to maintain their concentration on the focal point through at least a portion of the activity. For example, during a golf swing, the golfer tries to maintain his head in a steady position so that the club head consistently strikes the ball. To reinforce this movement, golfers are taught to keep their eye on the ball through impact with the ball. However, many golfers tend to follow the ball with their eyes and move their head during the swing resulting in inconsistent contact with the ball. Similarly, in baseball, batters are taught to keep their eye on the ball through contact with the ball. As in the golf swing, maintaining the position of the head and the eyes on the ball through impact can be a difficult skill to reproducibly put into practice.

Training methods and devices are needed to help subjects to maintain their head in the proper position during an activity, such as when swinging a golf club or trying to hit a baseball or softball.

### SUMMARY

Described herein are devices and methods for training a subject to maintain their head in a proper position during an activity by training the individual to concentrate on a focal point and to maintain a constant line of sight during an activity. An embodiment of the invention is directed to devices and methods utilizing retinal retention to train the subject to focus on a focal point during an activity. Exemplary embodiments include a retinal retention device having a surface with a color that contrasts with the color of an object that is placed in the line of sight between the subject and the device. The device and object can be included in a kit that may optionally include a structure for holding a ball, such as a tee. For example, in use, a ball having a first color can be placed on a card that is of a contrasting color to result in retinal retention when the subject causes the ball to be moved and the card remains, such as when hitting a golf ball.

Another aspect of the invention is directed to devices and methods utilizing visual memory acquisition to train the subject. Exemplary embodiments of the visual memory acquisition device include an object detector, a display, and a controller. This embodiment is configured such that an object is placed in the line of sight between the subject and an image on the display such that when the object is in position, the subject cannot see an image displayed on the display. The object detector indicates presence or absence of an object line of site between the subject and the display, and signals the controller accordingly. The controller receives a signal from the object detector and sends a signal to the display based on the signal from the object detector indicating the presence or absence of the object. The controller controls the image displayed on the display.

In use, the subject places an object in the line of sight between the subject and the display. The display displays an image. The subject causes the object to be moved while concentrating on maintaining a constant line of sight. An image is displayed on the display for a short period of time after the object is moved. If the subject has maintained the line of site throughout the activity of moving the object, then they will be able to observe and remember the image on the image display. If they have not maintained the line of sight, the image will disappear before they are able to reestablish the line of sight.

Embodiments of the device may be used to train subjects participating in numerous sporting activities including but not limited to golf, baseball, softball, and target shooting and may also be used to increase the situational awareness of law enforcement personnel, military personnel, security personnel and others. Embodiments of the device may also be used to improve the ability of subjects to concentrate who are suffering from neurological and psychiatric disorders. In addition to visual memory acquisition, the subject may utilize an object having a color that contrasts with the background color to induce retinal retention.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a top elevational view of an embodiment in of the invention for use with a ball.

FIG. 2 is a perspective view of an alternative embodiment in of the invention for use with a ball.

FIG. 3 is an enlarged perspective view broken away to show internal components and space of the embodiment of FIG. 2.

FIG. 4A is a perspective view of an alternative embodiment of the invention for use with a golf ball.

FIG. 4B is a cross section view of the alternative embodiment of the invention taken along line 4B-4B shown in FIG. 4A.

FIG. 5A is a perspective view of an embodiment of the invention for use with a softball or baseball.

FIG. 5B is an enlarged view of encircled area 5B of the embodiment of FIG. 5A.

FIG. 6A is a perspective view of an embodiment of a ball tee for use with embodiments of the invention.

FIG. 6B is a side view of an embodiment of the ball tee from FIG. 6A.

FIG. 7A is a perspective view of an alternative embodiment of a ball tee for use with embodiments of the invention.

FIG. 7B is a side view of an embodiment of the ball tee from FIG. 7A.

### DETAILED DESCRIPTION

Embodiments of the invention are directed to methods and devices for training a subject to concentrate on a focal point during an activity. Embodiments of the device and method utilize retinal retention, visual memory acquisition, and combinations thereof to train the subject to concentrate on the focal point during the activity.

Retinal retention is a phenomenon wherein the retina retains an image for a short period of time after the object being viewed disappears. Generally, retinal retention can be induced by concentrating for a period of time on an object having a first color that is in the line of site of a background having a second contrasting color. After concentrating on the object for the period of time, the object is removed. Due to retinal retention, the subject will continue to observe the object for a short period of time after the object has been moved. Because one must concentrate on the object to induce retinal retention, methods and devices that have the goal of inducing retinal retention are useful for training a subject to concentrate on an object to be moved during an activity. Moreover, since retinal retention is most effective when the object and the background are contrasting colors, the subject will be encouraged to not only concentrate on the object prior to object removal during the course of the activity, but will also be encouraged to maintain the line of sight to the contrasting background field in order to observe the retinal retention effect after causing the object to be moved.

In an embodiment, an object is placed in the line of sight between a subject and a display. The color of the display contrasts with the color of the object. The subject concentrates on the object for a period of time sufficient to induce retinal retention. In an embodiment, the period of time sufficient to induce retinal retention ranges from about 1 second to about 15 seconds or from about 2 seconds to about 10 seconds. In some embodiments, such as with certain object and background color combinations or with objects of a particular size or intensity, the period of time sufficient to induce retinal retention may be greater than about 15 seconds or between about 15 seconds and about 60 seconds. In other embodiments, the period of time sufficient to induce retinal retention may be less than about 15 seconds and even less than 2 seconds, such as between about 2 seconds and 0.1 seconds.

The colors of the object and the background are selected to improve the retinal retention of the image and to train the subject to maintain their concentration on a focal point throughout an activity. Generally, the object and the background are selected to contrast with one another. For example, brightly colored objects may be used with dark backgrounds or vice versa. By way of further example, the objects could be white, black, or pastel, fluorescent, or primary colors (such as pink, yellow, green, blue, red, and orange). The background is selected to contrast with the color of the object, such as black, white, or a contrasting pastel, fluorescent, or primary color, or have a darker shade, a lighter shade. For example, a red object could be used with a green background, green object on a yellow background, a blue object on a red background, or a white object on a black background, or vice versa.

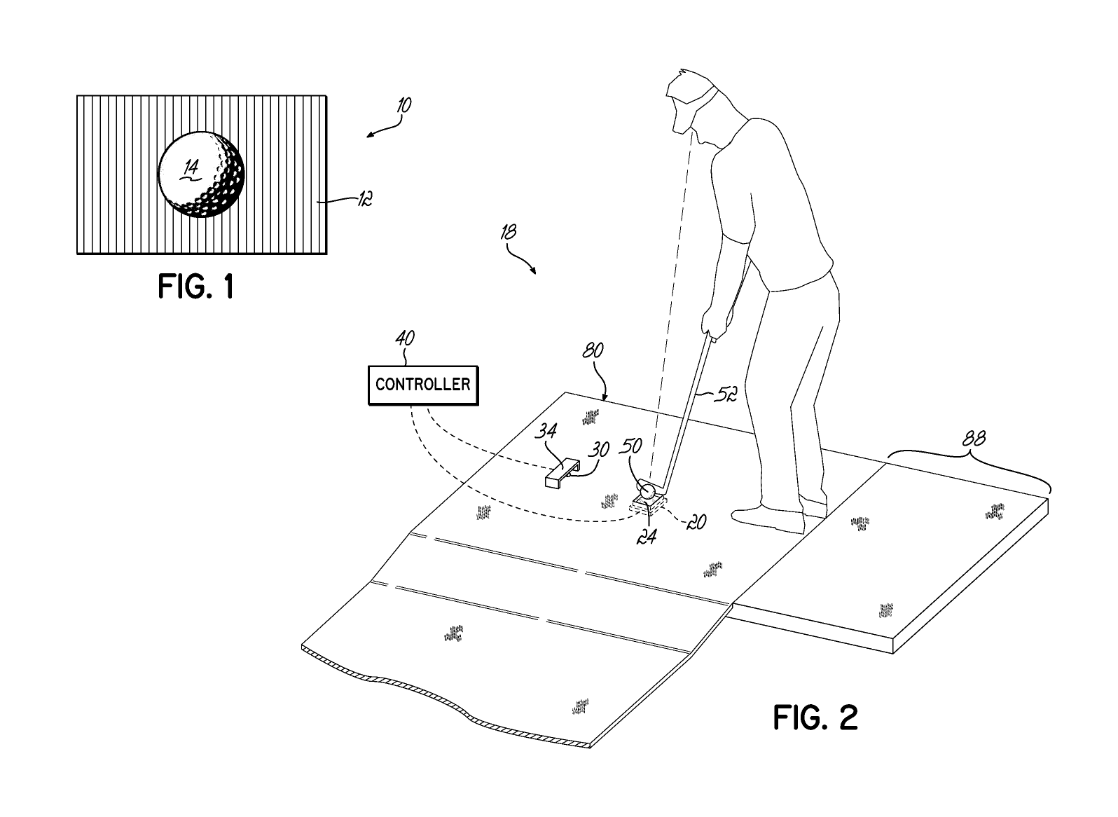

An exemplary device to practice the retinal retention method include a first surface displaying a first color that contrasts with the color of the object. The color of the first surface may be fixed and be in the form of a planar structure and of a size sufficient so that it may be seen along the periphery of the object. The device may include a section of material displaying the color of the first surface, such as paper, cardboard, plastic, metal, or fabric having the desired color. In an embodiment illustrated in FIG. 1, the retinal retention device 10 is a rectangular card with a background 12 of a first color. A ball 14 having a second color that contrasts with the first color is illustrated as being in the line of sight between the subject and the device 10.

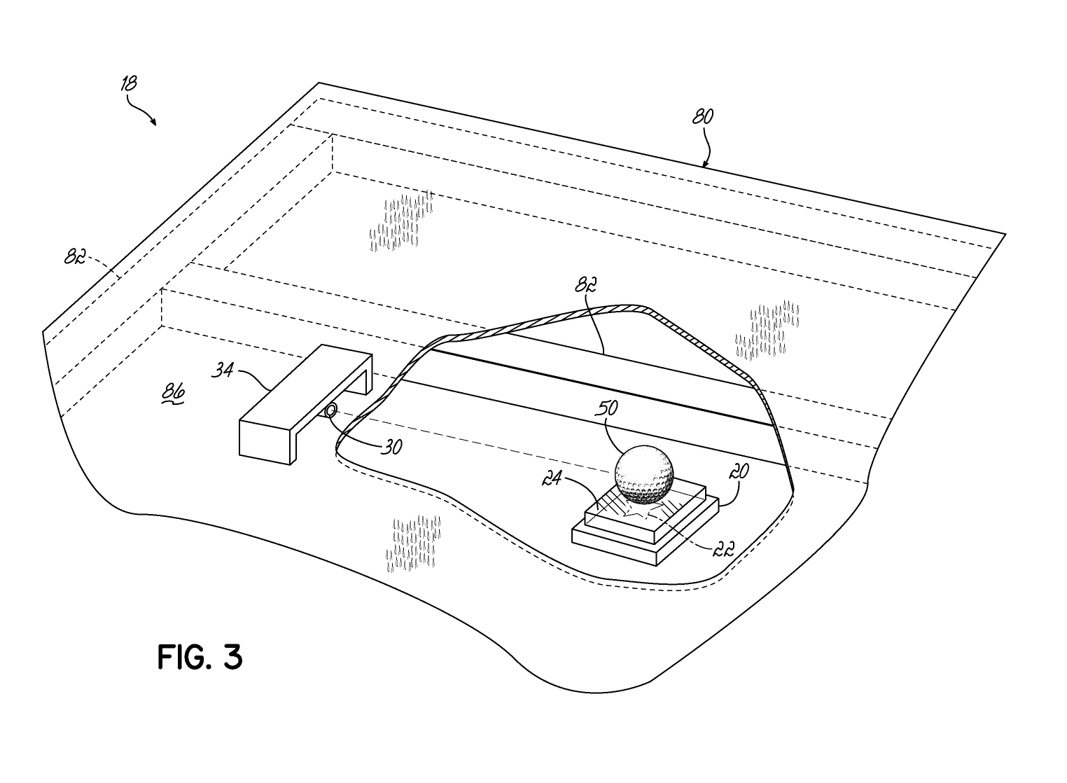

In an alternative embodiment, the device may include an electronic display for displaying the color of the first surface, such as display 20 in FIG. 2. For example, the electronic display 20 may be an LCD, LED, or electronic-paper screen, projector with screen, or other electronic display capable of producing a color that contrasts with the color of the object. The electronic display may be a part of a device 10 designed specifically for use with the methods disclosed herein or in a tablet and other mobile devices, such as a smart phone, e-reader. The color of the electronic display may be selected from a plurality of colors in order to contrast with the object. One of ordinary skill will appreciate that optics or screens may be utilized to protect the display 20 during use, such as protective screen 24 illustrated in FIG. 3.

During use, the subject may evaluate the shape of the retained image of the object to evaluate their performance. For example, if the retained image appears oval shaped with the long end of the oval aligned with the path of the ball, the shape of the oval indicates that the subject followed the ball with their eyes during the swing. If the retained image appears as an oval with the long end perpendicular with the path of the ball, the shape of the oval indicates that the subject moved their eyes from top to bottom on the ball. If the shape of the retained image is the same size and shape as the ball, the subject maintained their head position during the swing.

Another aspect of the invention utilizes the acquisition of visual memory to train a subject to concentrate on a focal point and to maintain a line of sight during an activity. As used herein, visual memory is the memory of an image seen by a subject in a short period of time after the object has moved out of the line of sight during an activity. In aspects of the invention, the subject is asked to concentrate on a focal point during the activity. At some point during the activity, an image appears for a short period of time in the line of sight of the focal point. After the short period of time, the image disappears and the subject is asked to identify the image that appeared. In an exemplary embodiment, the subject concentrates on an object that is in the line of sight between the subject and the image. During the activity, the object is moved revealing the image for a short period of time. After the passage of the short period of time, the image disappears and the subject attempts to recall the image. If the subject has changed their focal point or line of site during the activity, the object will have disappeared before the subject can shift his or her vision back to the location where the image was located and they will be unable to recall the image.

In an embodiment, the short period of time over which the image is available to be seen ranges from microseconds to milliseconds such as from 1 microsecond to about 500 milliseconds or about 1 millisecond to about 300 milliseconds or about 100 milliseconds to about 250 milliseconds or about 200 milliseconds. The image may be any image that can be quickly memorized by the subject. For example, the image may be a letter, a number, a shape such as a polygon, circle, or object, like a car, animal, face, etc. The size of the image may be adjusted to suit the subject's visual acuity as well as to increase or decrease the difficulty of the training session. For example, a smaller more complex image will require greater concentration to remember than a larger, simpler image.

In exemplary embodiments, the subject causes the object to be moved during the activity. For example, the object could be a ball, such as a golf ball, baseball, softball, or soccer ball and the user could move the ball by striking the ball. In another example, the object could be a target and the user could move the target by contacting with a projectile.

Thus, embodiments of the device and methods are useful for activities that require the subject to concentrate on a focal point or maintain a constant line of sight during an activity. The device and method are especially useful with activities that require the subject to maintain the position of their head during an activity, such as when keeping their eye on a ball in baseball, softball, and golf or on a target. Increasing the subject's ability to concentrate during an activity may improve performance in the activity and in other activities that require increased attention and concentration. Exemplary activities include sports (such as golf, target shooting, baseball, and cricket), tactical situations (such as to increase the tactical awareness police or military personnel), and medical rehabilitation and treatment of neurological or psychiatric disorders (such as opticokinetic nystagmus and other kinetic disorders, recovery from stroke, Parkinsons disease, and attention deficit and hyperactivity disorder in children and adults). Those skilled in the art will appreciate that the device and methods described herein can be modified as necessary for use with each of these activities.

Exemplary devices 18, 118, as illustrated in FIGS. 2-5B, include a display 20, 120, an object detector 30, 130, and a controller 40, 140 that controls the function of the display 20, 120 and receives data from the object detector 30, 130. In an embodiment, the display 20 generates the image 22 for visual memory acquisition and may also generate a background color for retinal retention. In an alternative embodiment, the background color is not provided by the display 20, but may be provided by another source of color such as a section of material, such as a section of paper, cardboard, fabric, plastic, metal, etc., having a color that contrasts with the color of the object.

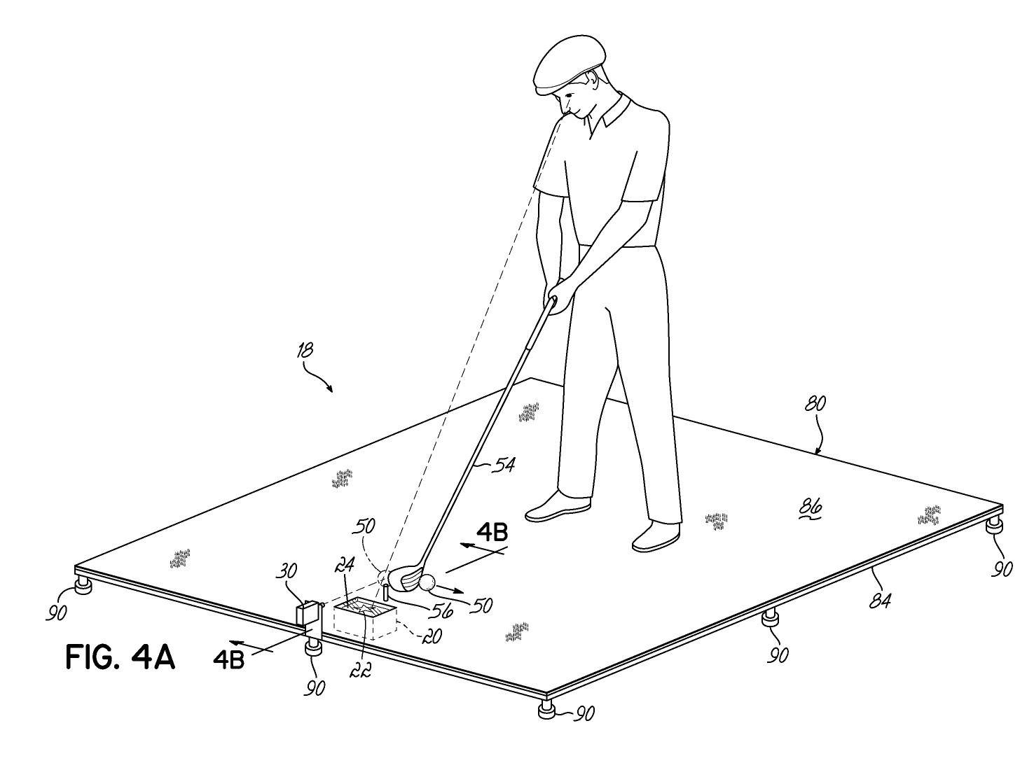

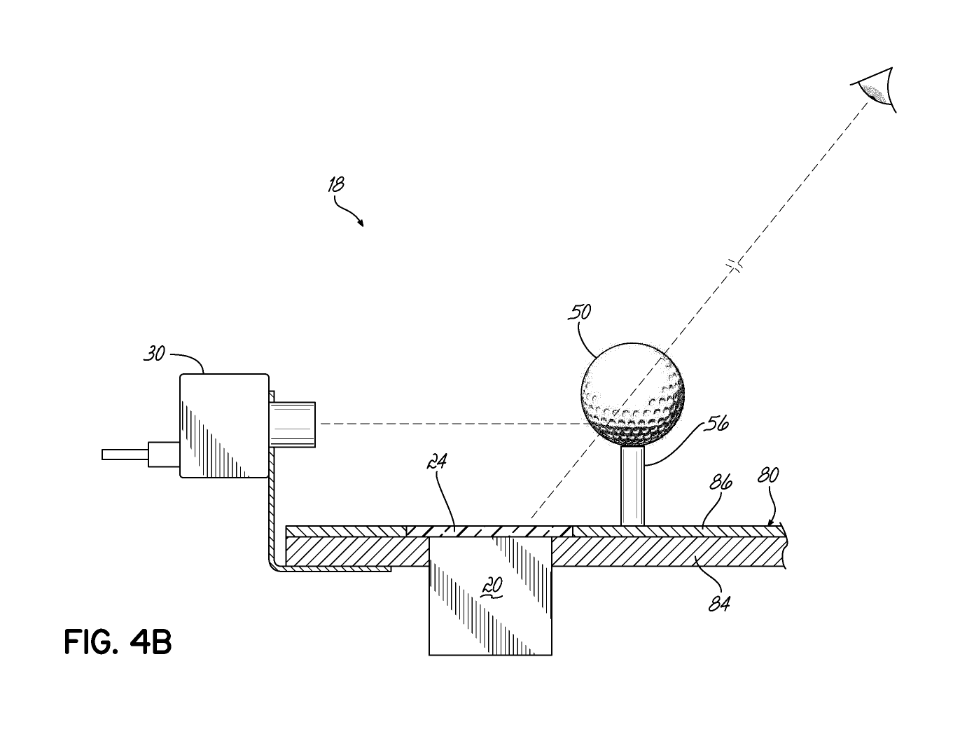

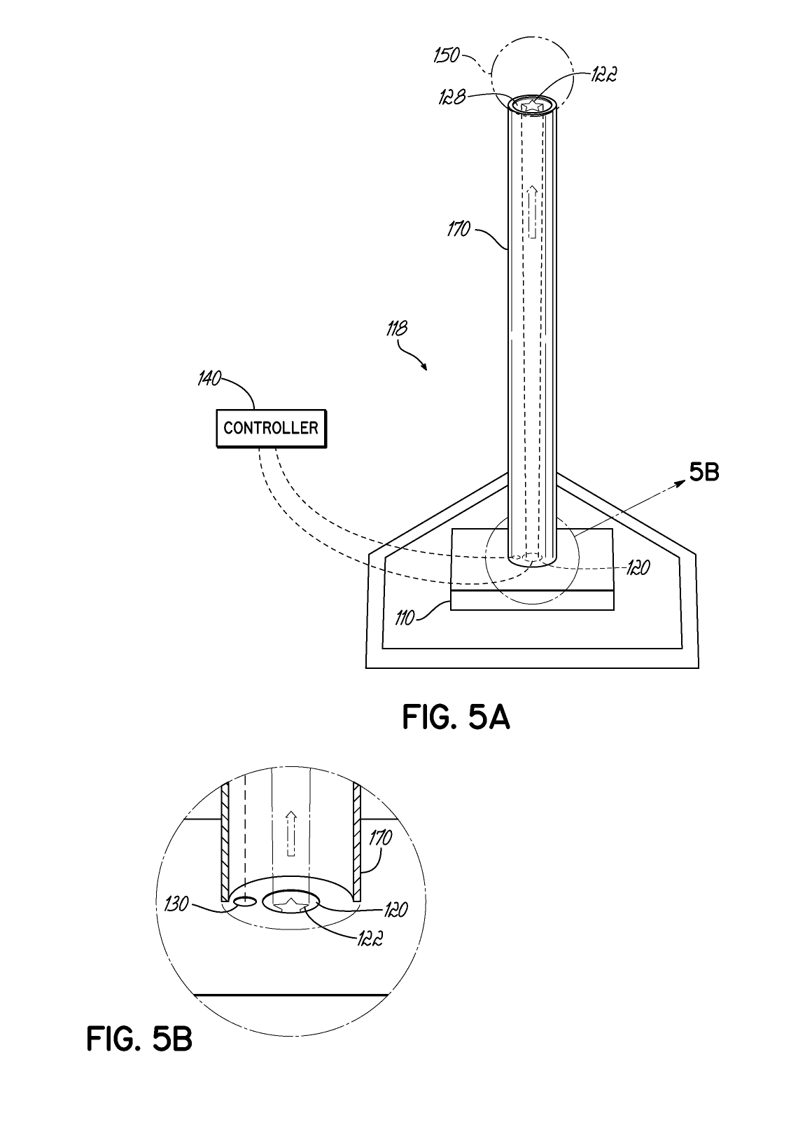

The display 20 in FIGS. 1-4 is shown as a relatively small display screen such as an LED screen, LCD screen, electronic-paper screen capable of generating the background color for retinal retention, the image for the acquisition of visual memory, or combinations thereof. The display may also be in the form of a projector (120 of FIG. 5B) or other image generating device capable of performing the functions described above. An aspect of the invention is that the object is capable of being placed in the line of sight between the subject and the display 20 over a portion of the background 12 for retinal retention and over the image 22 for acquisition of visual memory aspect so that the subject is not required to shift his line of sight during the activity to see the image 22 on the display 20 to acquire the visual memory after the object is moved. For example, in the illustrated exemplary embodiment illustrated in FIGS. 2-4B, the object is a golf ball 50 that is placed in the line of sight between the subject 60 and the image 22 and background 26 generated by the display 20. When the golf ball 50 is struck, such as with a putter 52 (FIG. 2), driver 54 (FIG. 4A), or iron, the image 22 is viewable for a short period of time in the line of sight (dashed line FIGS. 2, 4A, and 4B) directly behind the location where the ball 50 had been previously positioned thus requiring the subject to maintain their concentration on the focal point, i.e., the ball 50, before striking the ball (for retinal retention) and after striking the ball, focusing on the image 22 in the same line of sight (for visual memory acquisition). For other embodiments, such as for use with baseball (FIG. 5A and 5B), the object is a baseball 150 and the display 120 projects the image 122 to a translucent screen 128 on an upper end of a tee 170 on which the ball 150 sits. The image 122 appears on the translucent screen 128 at the top of the tee 170 behind where the ball 150 sat before the swing. For target shooting (not shown), the image appears behind a target that is moved when struck with a projectile. These other embodiments may utilize additional optics to project the image and protect the display during use. In the exemplary embodiment illustrated in FIGS. 2-4, the display 20 is protected by a screen cover 24 formed of a clear rugged plastic material such as polycarbonate. Other materials capable of protecting the display 20 may be used as well.

The exemplary embodiments illustrated in FIGS. 2-5B also include an object detector 30, 130. The object detector 30, 130 may include an optical detector such as a laser eye, or other device capable of detecting the presence and absence of the ball such as an acoustic detector or a mechanical detector. The object detector 30, 130 signals the controller 40, 140 to indicate the presence of a properly positioned object, such as a ball 50, 150, in the line of site between the subject and the spot where the image 22, 122 will be generated for the visual memory acquisition. The object detector 30, 130 also signals the controller 40, 140 when the ball 50, 150 is no longer present so as to start a timer for the short period of time for which the image is available to be viewed. After the desired amount of time has elapsed, the image 22, 122 will no longer be displayed on the display 20, 120. In other embodiments, the device 18, 118 may include an object detector 30, 130 that detects presence and absence of the object, such as a golf ball 50, baseball 150, target, etc. is in proper position. The object detector 30, 130 signals the controller 40, 140 regarding the presence or absence of the object in the proper position.

The controller 40, 140 receives signals from the object detector 30, 130, such as the ball detector, regarding the presence or absence of the object, e.g., the ball 50, 150. The controller 40, 140 also signals the display 20, 120 to control the display of the image 22, 122 for the visual memory acquisition, control the background color produced by the display 20, 120 for the retinal retention aspect of the invention, and may signal the display 20, 120 to produce instructions for the operation of the device by the subject. The controller 40, 140 may be built into the display 20, 120 or object detector, or may be a distinct unit operably coupled to the display 20, 120 and object detector. Likewise, the functions of the object detector 30, 130 and display 20, 120 may be incorporated into the same structure or these functions may be performed by different structures, as shown in the exemplary embodiment. For example, the controller 40, 140 may be a handheld device such as a phone or tablet device that communicates electronically or wirelessly with the object detector 30, 130 and display 20, 120. The controller 40, 140 could be a circuit built into the device housing the object detector 30, 130 and display 20, 120. The controller 40, 140 could be a desktop or laptop computer or mobile device.

The device and method may also include structures for evaluating the performance of the subject. For example, in one embodiment, the user may be asked to identify the image produced by the display 20, 120 and the device may include a structure for keeping score. The device may track the number of correct answers so that a subject earns over a given time period or number of attempts. The device may include an input device, such a key board, a food pad, a speech recognition system, and an interface for a mobile device to allow the subject to input and track their answers. In an embodiment, the device compares the subject's recalled image with the image displayed to determine the correctness of the identified image to assess the subject's performance. The device may track the subject's performance so that changes in performance may be observed and analyzed. The device may also include known analytical elements that measure and provide feedback about the speed and/or trajectory of the object, such as a ball, after it is hit, such as radar guns, laser systems, and optical systems. The device may also include structures that analyze and provide feedback to the subject regarding the path of the implement used to move the object, such as a golf club or baseball bat, which may provide data regarding club head speed, bat head speed, and the trajectory of the club head or bat head into the ball. Structures for analyzing the path of the implement are known, such as radar devices, laser devices, optical devices, and acoustic devices.

The exemplary embodiments illustrated in FIGS. 2-4 are directed to a devices 18 useful for training a subject to concentrate on maintaining the subject's head position during a golf swing. The device 18 may be used with a putter 52 (FIG. 2), iron, or wood 54 (FIG. 3). The device 18 includes a platform 80 housing the object detector 30, in this exemplary embodiment a laser, and the display 20, in this exemplary embodiment, a LCD monitor. The device 18 includes a protective screen 24 over the display 20 such as a rugged clear polycarbonate screen. The device 18 also includes a shield 34 protecting the object detector 30. The display 20 and object detector 30 are coupled to the controller 40 as previously described.

The platform 80 includes a supporting frame 82 and a base plate 84 forming the upper surface of the platform 80. The supporting frame 82 and base plate 84 may be made from suitable materials as known to those of ordinary skill in the art such as metal (such as aluminum, steel, and other alloys), plastic, composite materials, wood and combinations thereof. The upper surface 86 of the platform may be covered with a material that mimics a grass surface that may extend into a putting surface that includes a target such a hole. A platform extension 88 may be used to extend the surface on which the subject stands while using the device, such as when using the device with a longer club like an iron or a driver. The platform 80 may be set up for use from either the left or right side. The platform 80 may also include adjustable legs 90 (FIG. 4A) allowing the platform 80 to be leveled or to create an incline.

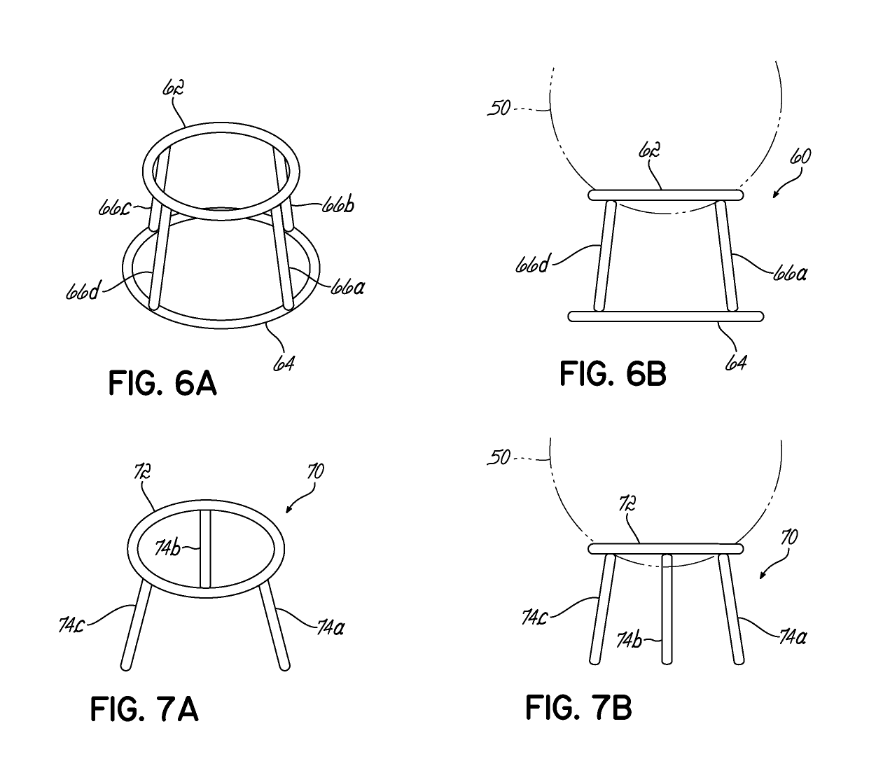

The ball 50 may rest directly on an indention in the protective screen, as illustrated in FIGS. 2 and 3, or on a support such as a ring tee 60, 70 (FIGS. 6A-7B) or standard tee 56 (FIGS. 4A and 4B) that supports the ball 50 above in the line of sight between the subject and the image such that the ball 50 obstructs the subject's view of the image 22 while not obstructing the subject's view of the image 22 after hitting the ball 50. Exemplary ring tees suitable for this purpose are illustrated in FIG. 6A-7B. FIG. 6A and 6B illustrate a perspective view and a side view, respectively, of an exemplary embodiment of a suitable ring tee 60 having an upper ring 62, a lower ring 64, and a plurality of legs, in this instance four legs 66a, 66b, 66c, and 66d, joining the upper ring 62 to the lower ring 64. Fewer legs may be used with this embodiment. The upper ring 62 supports the ball 50(shown in phantom lines) and the legs 66a, 66b, 66c, and 66d support the upper ring 62 on the lower ring 64, which contacts the device (not shown). FIGS. 7A and 7B illustrate an alternative exemplary embodiment of a suitable ring tee 70 having a ring 72 and a plurality of legs, in this instance 3 legs 74a, 74b, 74c, but more legs could be used at desired. The ring 72 supports the ball 50 (shown in phantom lines) and the legs 74a, 74b, 74c support the ring 72 on the device 10 (not shown). The rings 62, 72 of the exemplary ring tee designs prevent the ring tees 60, 70 from obstructing the subject's view of the image 22 on the display 20 after hitting the ball 50. The ring tees 60, 70 may be made from plastic, metal, such as metal wire, or other suitable material.

FIGS. 5A and 5B illustrates an alternative embodiment of the invention for use with a softball or baseball 150 or other similar type ball that is hit with a bat. This embodiment utilizes a base plate 110 housing an display 120, an object detector 130, and a elongated tee 170 for supporting a ball 150. The elongated tee 170 extends up from the base plate 110. In this embodiment, the display 120 projects an image 122 onto a translucent screen 128 located beneath the ball 150. The translucent screen 128 and elongated tee 170 are easily replaceable. The display 120 and the object detector 130 are coupled to a controller 140 either electronically or wirelessly as described in greater detail above.

The embodiments of the devices for practicing the methods may optionally be included in a kit that includes the device and at least one object to be moved. In an embodiment for use with a ball, such as a golf ball, the kit would include at least one device and at least one ball. In retinal retention kits having devices with a fixed first color, the kit may optionally include a plurality of devices having a plurality of colors, such as a plurality of colored cards. In addition, the kit may include a plurality of balls, such as golf balls, wherein each ball has a color that contrasts with the color of the surface of the device. In addition, kits for use with tablets or other mobile device may include a protective screen to protect the subject's device, as well as a source code controlling the color of the device's display. The kits may optionally include a ring tee or other structure for maintaining the position of the object prior to the subject causing the object to be moved.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A device for training a subject to concentrate on a focal point during an activity, the device comprising:
an object detector, an image generator, and a controller.

2. The device of claim 1 wherein the object detector detects the presence of a ball or a target.

3. The device of claim 1 wherein the object detector is a laser.

4. The device of claim 1 wherein the image generator is selected from the group consisting of an LCD screen, an LED screen, and projector.

5. The device of claim 1 wherein the image generator is capable of generating an image and a background color.

6. The device of claim 1 wherein the controller receives a signal from the object detector and sends a signal to the image generator in response to the signal from the object detector.

7. The device of claim 1 wherein the device is configured to train a subject to concentrate on at least one of a golf ball, a baseball, a softball, a target, and combinations thereof.

8. (canceled)

9. A method of training a subject to concentrate on a focal point during an activity utilizing the device of claim 1.

10. (canceled)

11. A method of training a subject to concentrate on a focal point during an activity, the method comprising:
placing an object in the line of sight between a subject and an image generator;
causing the object to be moved from the line of site; and
displaying an image on the image generator for a period of time beyond the instant the object is moved from the line of sight between the subject and the image generator.

12. The method of claim 11 further comprising detecting the presence and absence of the object with an object detector.

13. The method of claim 11 wherein the image is present for a period of time ranging between about 1 microsecond to about 500 milliseconds.

14. The method of claim 11 wherein the image is selected from the group consisting of a letter, a number, a shape, an object, or combinations thereof.

15. The method of claim 11 wherein the image generator displays a background color that contrasts with the object.

16. The method of claim 11 wherein the image generator displays instructions to the subject.

17. The method of claim 11 further comprising tallying the number of correct images observed by the subject.
